(19) United States
(12) Patent Application Publication
(10) Pub. No.: US 2017/0259997 A1
(43) Pub. Date: Sep. 14, 2017

(54) METHOD FOR A FULLY AUTOMATIC AND/OR SEMIAUTOMATIC SETUP OR CALIBRATION OF A PICK AND/OR PLACE POSITION

(71) Applicant: Liebherr-Verzahntechnik GmbH, Kempten (DE)

(72) Inventors: Thomas Mattern, Rieden am Forgensee (DE); Markus Zollitsch, Haldenwang (DE); Robert Stetter, Betzigau (DE)

(21) Appl. No.: 15/448,091

(22) Filed: Mar. 2, 2017

(30) Foreign Application Priority Data
Mar. 8, 2016 (DE) 10 2016 002 815.7

(51) Int. Cl. B65G 1/04

(52) U.S. Cl. CPC B65G 1/0492

(57) ABSTRACT

The invention relates to a method for the fully automatic and/or semiautomatic setup or calibration of a pick and/or place position having at least one storage and retrieval vehicle and/or at least one trolley, a control/regulation device, at least one detection system, in particular an optical detection system, and at least one position feature, the method comprising the following steps:
manual and/or automatic storage of the positions of the position features;
automatic traveling to the stored positions by means of the storage and retrieval vehicle and/or of the trolley:
detecting an actual value of the position of the position feature by means of the detection system, in particular an optical detection system; and
calculating a difference between the stored position and the actual value, optionally carrying out a correction, and optionally storing a correction value of the position of the position feature.

### BACKGROUND OF THE INVENTION

The invention relates to a method for a fully automatic and/or semiautomatic setup or calibration of a pick and/or place position, comprising at least one storage and retrieval vehicle and/or at least one trolley, at least one control/regulation device, at least one detection system, in particular an optical detection system, and at least one position feature. The invention furthermore relates to a system that is configurable to carry out a method for fully automatic and/or semiautomatic setup or calibration.

An apparatus for the fine positioning of a storage and retrieval vehicle at a bay of a high rack storage warehouse is known from DE 10 2013 111 187 A1. It is known in this respect that a setup mode preceding the process operation has to be carried out as a requirement for an exact fine positioning. The setup mode is in this respect, however, carried out by the user by means of a display at the display unit by adjusting an optical sensor at a holder. The optical sensor is in this respect aligned exactly to a marking at the respective bay. After the alignment of the optical sensor, the setup mode is ended, with the storage and retrieval vehicle autonomously moving to individual bays for loading or unloading with articles in process operation. The fine positioning of the storage and retrieval vehicle in this respect takes place autonomously in process operation. It is, however, disadvantageous in this respect that the setup mode has to take place manually in advance by a user and that no automation is present in this respect. This has the effect that the setup mode is time-consuming and prone to error.

Methods are likewise known for the setup of a high bay store and/or of a machine, a setup station, a measuring station or a cleaning station that have previously taken place manually by machine setup technicians or mechanics. The basis for the known system is preferably formed by standardized machine pallets on which the workpieces to be processed or the product to be stored and/or transported is/are mounted manually or automatically. Other pallets can likewise be provided on which the workpieces to be processed or the product to be stored and/or transported is positioned manually or automatically. The Euro-pallets also known per se can equally be used in addition or alternatively to the machine pallets to store the workpiece to be processed thereon. In setup mode, the storage and retrieval vehicle in this respect has to be traveled manually by the machine setup technician or mechanic to the respective high bay station, to the setup station, to the measuring station, to the cleaning station or to the machine. The position of the storage and retrieval vehicle is then determined and stored and, as required, the position of the storage and retrieval vehicle relative to the high bay station or to the setup station, to the measuring station, to the cleaning station or to the machine is adapted and saved so that a loading or unloading can be carried out in the corresponding position of the storage and retrieval vehicle. The manually detected position data are stored in a control/regulation device, whereby a setup of the storage and retrieval vehicle is achieved. It is disadvantageous in this system known from the prior art that the manual teaching of the storage and retrieval vehicle is very time-consuming since the setup or calibration of a storage and retrieval vehicle takes up a lot of time in dependence on the size of the high bay store and on the number of external unit such as machines, setup stations, measuring stations, cleaning stations since the operator has to reach every position, which is frequently only possible with the aid of ladders or similar. In addition, the known teaching method is prone to error since errors in manual traveling in setup mode can occur and thus erroneous position data can be stored.

### SUMMARY OF THE INVENTION

It is therefore the object of the invention to provide a method for a fully automatic and/or semiautomatic setup or calibration of a pick position and/or place position that can be carried simply, in a time-saving manner and fully automatically or semiautomatically.

This object is achieved in accordance with the invention by a method for the fully automatic and/or semiautomatic setup or calibration of a pick and/or place position having the features herein.

The method for the fully automatic and/or semiautomatic setup or calibration of a pick and/or place position is equipped with at least one storage and retrieval vehicle and/or at least one trolley, a control/regulation device, at least one detection system, in particular an optical detection system, and at least one position feature, the method comprising the following steps:
manual and/or automatic storage of the positions of the position features;
automatic traveling to the stored positions by means of the storage and retrieval vehicle and/or of the trolley:
detecting an actual value of the position of the position feature by means of the detection system, in particular an optical detection system; and
calculating a difference between the stored position and the actual value, optionally carrying out a correction, and optionally storing a correction value of the position of the position feature.

It should be achieved by means of such a method that the storage and retrieval vehicle or the trolley can be exactly positioned relative to the place position such that a collision-free and exact loading and unloading of the system, the machine, the setup station, the measuring station or the cleaning station can be achieved.

Preferred embodiments of the invention result from the description herein.

The storage and retrieval vehicle can be an apparatus that is adapted to move in a horizontal direction, to manipulate, in particular to grip, and to travel storage product. The storage and retrieval vehicle can in this respect be an automatic apparatus.

The trolley possibly provided at the storage and retrieval vehicle is travelable in the vertical direction in this respect.

Such a configuration provides the advantage that the fully automatic and/or semiautomatic setup or calibration method represents a smaller time effort since savings in working time can be achieved by the shortened time of the setup mode. The proneness to error is likewise smaller due to the automation since the risk of human error in the manual setup mode can be reduced.

It is possible in a preferred embodiment that the method is carried out by means of a search trip of the storage and retrieval vehicle and/or trolley fully automatically by detecting the position of the position features by the detection system, in particular the optical detection system, and the storage of the positions of the position features and the setup of the storage and retrieval vehicle and/or of the trolley is achieved. For this purpose, only the detection system, in particular the optical detection system, has to be attached to the storage and retrieval vehicle in a first step of the method. The geometrical configuration, in particular width, height and depth, of the high bay store, in particular the high bay stations, to be loaded or unloaded in accordance with the method is not decisive for the method. Naturally, more than one high bay station or one machine, one setup station, one measuring station, one cleaning station can thus be used in accordance with the method for the fully automatic and/or semiautomatic setup or calibration. A high bay store is likewise not necessarily understood as a linearly extending high bay store, but rather also as a round bay store.

The method can be carried out as follows under the aspect of the fully automatic setup and/or calibration. The storage and retrieval vehicle fully automatically travels to a position feature and stores the recognized position in the regulation/control unit. The further position features are subsequently traveled to, detected and stored by means of the detection system, in particular the optical detection system. An important step of the setup or calibration process of the storage and retrieval vehicle takes place by the search trip carried out. The larger the number of high bay stations, the greater the effect of the time saving in the fully automatic and/or semiautomatic setup or calibration of the high bay store.

It is possible in a further preferred embodiment that the setup and/or calibration of the storage and retrieval vehicle and/or trolley is achieved by means of a manual storage of the positions, in particular by means of CAD data and a subsequent position comparison trip by means of the detection system, in particular the optical detection system. The method can be carried out as follows under the aspect of the semiautomatic setup and/or calibration.

If the first position to be traveled to is not initially stored, the machine setup technician or mechanic has to travel to the first high bay station manually. The position is then determined by means of the detection system, in particular the optical detection system, and is stored in the regulation/control unit. After the storage of the first high bay station, the storage and retrieval vehicle travels autonomously to the first manually stored position. After the detection or recognition of the first position, the storage and retrieval vehicle and/or the trolley can subsequently travel to the further positions automatically, by means of manually stored coordinates, in particular CAD data, can detect and optionally correct the position feature by means of the optical detection system and can store the correction value in the regulation/control unit. The correction value is in this respect stored when the difference between the stored position and the actual value is larger than a predefined amount. If a plurality of geometrically different high bay stations are present, different maximum difference values can also be associated with them. The detected data or positions are stored in the control/regulation device. The control/regulation device can have corresponding storage media for this purpose. A major step of the setup and calibration process of the storage and retrieval vehicle takes place for each high bay station with the storage of the position of the position feature.

Since the associated position of the position feature is stored in the course of the setup, the storage and retrieval vehicle can autonomously travel to the corresponding position features after running through or ending the fully automatic or semiautomatic setup of the storage and retrieval vehicle and can carry out a loading or unloading with respect to the position of the stored position features with knowledge of the position of the high bay station, of the machine, of the setup station, of the cleaning station or measuring station. The stored position features from a previous calibration process can equally be used in order optionally to carry out readjustments. Not only pure readjustments are to be understood by this, but rather possible service work, possible repair work, possible collision cases, etc.

It is possible in a further preferred embodiment that the placement position and the picking position is configured as a first unit, in particular as a high bay store, and the placement and picking is carried out by means of the storage and retrieval vehicle and/or of the trolley. The placement and picking of machine pallets, other pallets or Euro-pallets can thus take place precisely and collision-free in the high bay store.

In a further preferred embodiment, the picking position and the placement position can be configured as a second unit, in particular as a machine, a cleaning station, a measuring station and/or a setup station, and the picking and placing are carried out by means of the storage and retrieval vehicle and/or of the trolley. The picking and placement of machine pallets, other pallets or Euro-pallets can thus takes place precisely and in a collision-free manner from the machine, the cleaning station, the measuring station and/or the setup station.

It is likewise advantageous that the machine pallets, other pallets or Euro-pallets are picked from the high bay store and are placed into the machine, the cleaning station, the measuring station and/or the setup station.

In a further preferred embodiment, the position feature can be configured as a structural element that can be detected by means of the detection system, in particular the optical detection system. A structural element can be understood as a continuous opening, in particular a hole and/or a recess and/or an elevated portion. The continuous opening and/or recess can in this respect be provided at a structure of the corresponding high bay station, of the corresponding machine or measuring station or of the setup station or cleaning station such that, in an advantageous manner, no additional apparatus such as mirrors or similar have to be provided as a position feature. It can be sufficient, for example, to drill an initial bore at or to drill through a support of a high bay station that is preferably arranged at the side of the high bay store directed to the storage and retrieval vehicle or to the trolley to provide a corresponding position feature configured as the structural element.

In a further preferred embodiment, the method can be carried out independently of the number and of the geometrical configuration, in particular the width, height and depth of the high-bay stations, machines, cleaning stations, measuring stations and/or setup stations. A high flexibility can hereby be provided and, despite a low time effort, the storage and retrieval vehicle can be automatically and reliably set up or calibrated.

In accordance with a further preferred embodiment, the detection system, in particular the optical detection system, can be configured as mountable to the storage and retrieval vehicle and can be separated after carrying out the fully automatic and/or semiautomatic setup or calibration of the storage and retrieval vehicle. After carrying out the setup mode or calibration mode in accordance with the invention, all the positions of the position features are stored. Since the high bay stores can be stationary high bay stores that cannot be easily changed, a repeat detection of the position features by means of the detection system, in particular of the optical detection system, is then no longer automatically necessary, but is only used again as part of a possibly required calibration method.

To counteract damage to the detection system, for example by falling load, it can be dismantled after carrying out the method in accordance with the invention.

In a further preferred embodiment, an exactly definable position of the position feature with respect to the workpiece support and/or machine support and/or other reference surface may be required for a precise position detection and can be stored in the control/regulation device. It is thus particularly advantageous if the position between the storage and retrieval vehicle or the trolley is positioned such that a collision-free and exact loading or unloading is made possible since the pallets are placed or picked by means of a loading or unloading apparatus. To be able to carry out such a precise positioning, an exact fixing of the position of the storage and retrieval vehicle or of the trolley is necessary with respect to the position feature of the high bay system or high bay station and of the machine, the setup station, the cleaning station or the measuring station. The position of the position feature with respect to the workpiece support likewise has to be exactly fixed since otherwise no automation of the setup mode would be possible.

The invention is furthermore directed to a system having at least one pick and/or place position, at least one storage and retrieval vehicle, and/or at least one trolley, at least one control/regulation device, at least one detection system, in particular an optical detection system, and at least one position feature, wherein the system is configured for carrying out a method for the fully automatic and/or semiautomatic setup or calibration in accordance with the description herein.

### BRIEF DESCRIPTION OF THE DRAWINGS

Further features, details and advantages of the invention result from an embodiment shown with reference to the drawing. There are shown:

FIG. 1: a high bay store with a storage and retrieval vehicle for carrying out the method in accordance with the invention;

FIG. 2: a trolley with an optical detection system: and

FIG. 3: a perspective view of a system with an internal unit, in particular a high bay store, an external unit, in particular a machine, a cleaning station, a measuring station, and a storage and retrieval vehicle.

### DESCRIPTION OF THE PREFERRED EMBODIMENTS

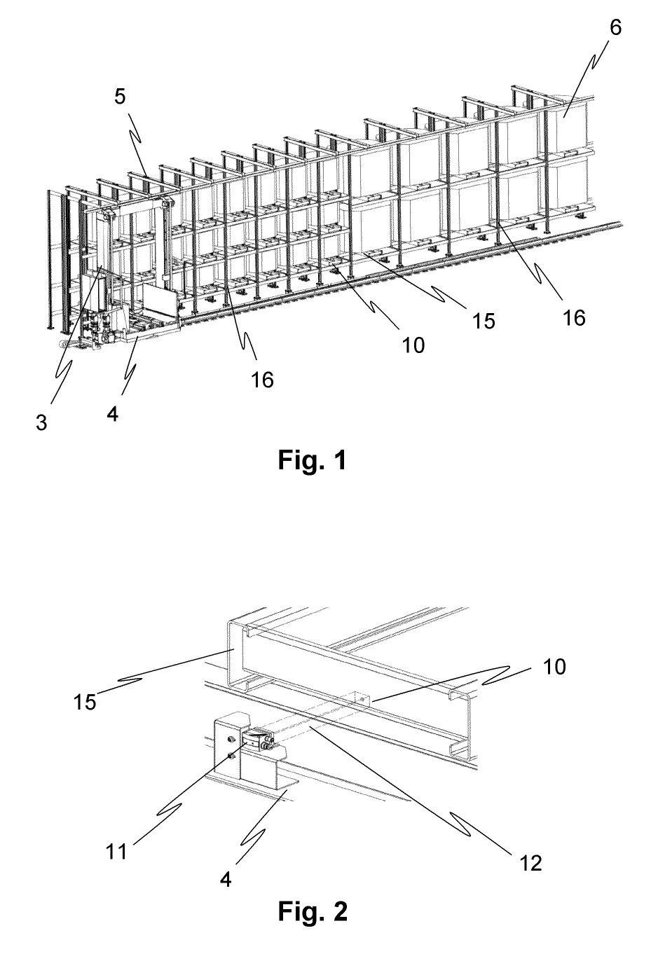

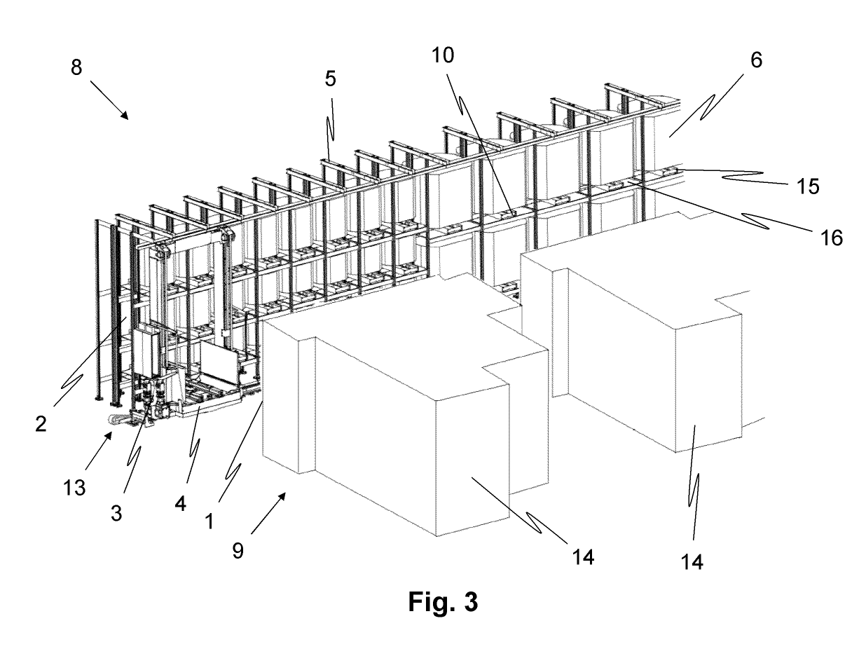

FIG. 1 shows a high bay store system that is configured for carrying out the method in accordance with the invention. It comprises a high bay store 5 or a general store 5 that is configured for picking and placing machine pallets, other pallets or Euro-pallets as well as other storage product. A storage and retrieval vehicle 3 that is coupled to a trolley 4 serves the loading and unloading of the individual high-bay stations 16. In the embodiment of FIG. 1 shown, the high bay store 5 is configured as a pallet store. The feature store or high bay store should be interchangeable in this respect, with the general feature of the high bay store 5 being preferred. A detection system 11, in particular an optical detection system, can be provided at the storage and retrieval vehicle 3 or at the trolley 4 by means of which the position features 10 of individual high bay stations 16 can be detected.

The storage and retrieval vehicle 3 can be traveled in the two travel directions 20, 21, with more or fewer travel directions likewise being conceivable. Workpieces 6 can, for example, be stored or storable on corresponding workpiece receivers 7 within the high bay store 5.

In accordance with the invention, a position of the position feature 10 of at least one first storage station 16 is input into the control/regulation device. The storage and retrieval vehicle 3 then automatically travels to the position in accordance with the stored position of the first storage station 16. A plurality, and in particular all, of the stored positions can naturally also be input in the first step provided that more than a first unit 13 and/or second units 9 are present. Machines 14, setup stations 14, cleaning stations 14, and measuring stations 14 are understood as the second unit 9.

Depending on whether the storage and retrieval vehicle 3 is coupled to a trolley 4 and on whether the detection system 11 is coupled to the storage and retrieval vehicle 3 or to the trolley 4, the position of the first high bay station 16 can also be alternatively or simultaneously be traveled to by the trolley 4.

If the detection system 11 is now in the region of the first position feature 10, the exact position of this position feature 10 is detected by means of the detection system 11. An optionally present difference between the actual value and the detected position of the position feature 10 is then calculated and a correction value is optionally stored. The correction value can in particular be stored when the difference between the actual value and the stored or detected position exceeds a predefined limit value. The storage and retrieval vehicle 3 subsequently travel fully automatically to the individual position features 10, detects them and stores them in the control/regulation unit.

The method can be repeated with the individual steps for so long until all the high-bay stations 16 have been automatically set up. For this purpose, the position of all the internal units 13 or external units 9 to be taught can be stored at the start of the method, for example by means of CAD data, so that the last two steps of the automatic travel, of the detection of the position of the position features 10 and of the calculation of a difference can thereupon be repeated for all previously stored positions. After the detection of the last stored position of the position feature 10 of the last high bay station 16, the semiautomatic setup of the high-bay store 5 is ended.

In this respect, a position feature 10 that is configured in the form of a structural element can be associated with each high bay station 16, each machine 14, each setup station 14, each measuring station 14 and/or each cleaning station 14. The structural element can be configured as a continuous opening, preferably a hole or a bore or a surface recess or an elevated portion. The structural element has to be configured such that the detection system 11, preferably the optical detection system, can unambiguously detect it. Such a position feature 10 is likewise preferably arranged on the side of the high bay store 2 directed toward the storage and retrieval vehicle 3. The position recognition can be carried out with the aid of the optical detection system 11, preferably a 2D camera or a 3D camera. The detected stored position is compared within a detection zone 12 of the 2D camera used here and is automatically corrected and stored in the event of differences. An automatic setup or calibration of a system 1 can thus be implemented.

This embodiment has the advantage that no additional apparatus are required at the high bay store 5 since the continuous openings or recesses can be applied in a time-saving and low-cost manner in the manufacturing method of the high bay store 5 or of the components of the high bay store 5. The position features 10 can be applied directly in the manufacturing method of the high bay store 5 and of the machines 14, measuring stations 14, setup stations 14 or cleaning stations 14 so that no additional assembly effort arises during the assembly.

The setup of storage and retrieval vehicles 3 takes place with a substantial time effort and in dependence on the number of storage stations 16 in accordance with the prior art. The method in accordance with the invention therefore offers the advantage that no manual setup process is required since the positions can be automatically traveled to with the aid of the trolley 4 or of the storage and retrieval vehicle 3 and can be detected and corrected by the detection system 11, in particular the optical detection system, whereby the correction values of the positions are stored. In addition, the method in accordance with the invention reduces the necessity of manual activities such that the risk through manual errors on the manual traveling in setup mode can be reduced.

The input theoretical position of the position feature 10 of the first high bay station 16 or the stored positions of all high bay stations 16, machines 14, setup stations 14, measuring stations 14 and/or cleaning stations 14 are automatically traveled to by means of the trolley 4 or by means of the storage and retrieval vehicle 3 and the corresponding position features 10 are detected, preferably with an optical detection system 11, in particular a 2D camera or 3D camera. The relative position of the attached position features 10 with respect to the workpiece support 15 or to the storage stations 16 or to other reference surfaces has to be exactly defined and stored in this respect. After the detection of the stored position, the trolley 4 or the storage and retrieval vehicle 3 can subsequently travel automatically, by means of the stored position, preferably CAD data, to the further high-bay stations 16. The detection system 11, in particular optical detection system, detects and optionally corrects the position feature or their position features 10 and the correction values are stored in the control/regulation device.

If a first position is initially not known, it is also conceivable to carry out the method such that a machine setup technician travels manually to the first high bay station 16 and hereby inputs the position. The position can in this respect be determined by means of the optical detection system 11 and can be stored in the control/regulation device or can be manually input by the machine setup technician. The position of the attached position features 10 relative to the workpiece support 15 or to the corresponding high bay station 16 has to be exactly defined and stored in this respect.

It is advantageous in this respect that the putting into operation or the automatic fully automatic and/or semiautomatic setup and/or calibration in accordance with the method and the alignment of the storage and retrieval vehicle 3 can be carried out with the aid of the optical detection system 11 and of the stored positions. It is likewise advantageous that an automatic, correct alignment of the optical detection system 11 with respect to the position features 10 can be carried out on the putting into operation or in the fully automatic and/or semiautomatic setup or calibration in accordance with the method.

Provision can furthermore advantageously be made that the position features 10 are configured in the form of a continuous opening, preferably in the form of a hole.

It is furthermore advantageous if the storage and retrieval vehicle 3 and the optical detection system 11 are configured such that in particular the width, the height, and the depth of the high-bay stations 16, machines 14, cleaning stations 14, measuring stations 14 and/or setup stations 14 can be detected or operated independently of the number and of the geometrical configuration. A high flexibility of the system 8 can thus be provided and the storage and retrieval vehicle 3 can be taught automatically and reliably despite a small time effort.

Provision can furthermore advantageously be made that the detected data are stored in the control/regulation device for determining the position by means of a position feature 10 of the high bay station 16. The detected data can be accessed and used at any time due to the storage. The position correction of the setup process is stored in the control/regulation device and does not require any repeat position detection. This storage has the advantage that, with any possible readjustments, the data already stored in the control/regulation device can be used and corrections only have to be made in the event of differences.

The pick position 1 likewise in particular comprises a machine 14, a setup station 14, a measuring station 14 and/or a cleaning station 14 that are configured for placing and/or picking machine pallets, other pallets or Euro-pallets as well as other storage product.

1. A method for a fully automatic and/or semiautomatic setup mode or calibration of a pick (1) and/or place position (2), comprising
at least one storage and retrieval vehicle (3) and/or at least one trolley (4);
a control/regulation device;
at least one detection system (11), in particular an optical detection system; and
at least one position feature (10),
wherein the method comprises the following steps:
manual and/or automatic storage of the positions of the position features (10);
automatic traveling to the stored positions by means of the storage and retrieval vehicle (3) and/or of the trolley (4);
detecting an actual value of the position of the position feature (10) by means of the detection system (11), in particular an optical detection system; and
calculating a difference between the stored position and the actual value, optionally carrying out a correction, and optionally storing a correction value of the position of the position feature (10).

2. A method in accordance with claim 1, wherein the storage of the positions of the position features (10) is carried out and the storage and retrieval vehicle (3) and/or trolley (4) is set up by a search trip of the storage and retrieval vehicle (3) and/or trolley (4) fully automatically by detecting the position of the position features (10) by the detection system (11), in particular the optical detection system.

3. A method in accordance with claim 1, wherein the storage and retrieval vehicle (3) and/or the trolley (4) is setup or calibrated by a manual storage of the position of the position data, in particular by CAD data, and a subsequent position comparison trip by the detection system (11), in particular the optical detection system.

4. A method in accordance with claim 1, wherein the place position (2) and the pick position (1) is configured as a first unit (13), in particular as a high bay store (5) and the placing and picking is carried out by the storage and retrieval vehicle (3) and/or of the trolley (4).

5. A method in accordance with claim 1, wherein the pick position (1) and the place position (2) is configured as a second unit (9), in particular a machine (14), a cleaning station (14), a measuring station (14) and/or a setup station (14) and the picking is carried out by the storage and retrieval vehicle (3) and/or of the trolley (4).

6. A method in accordance with claim 1, wherein the position feature (10) is configured as a structural element that can be detected by the detection system (11), in particular an optical detection system.

7. A method in accordance with claim 1, wherein the method is carried out independently of the number and of the geometrical configuration, in particular the width, height and depth of the pick (1) and place positions (2).

8. A method in accordance with claim 1, wherein the detection system (11), in particular the optical detection system, is configured as mountable to the storage and retrieval vehicle (3) and is separated after carrying out the fully automatic and/or semiautomatic setup or calibration of the storage and retrieval vehicle (3).

9. A method in accordance with claim 1, wherein an exactly definable position of the position feature (10) with respect to the workpiece support (15) and/or the machine support and/or other reference surface is provided and is stored in the control/regulation device for a precise position detection.

10. A system (8) having
at least one pick (1) and/or place position (2),
at least one storage or retrieval vehicle (3) and/or at least one trolley (4),
at least one control/regulation device,
at least one detection system (11), in particular an optical detection system, and
at least one position feature (10), for carrying out a method in accordance with claim 1.

11. A method in accordance with claim 2, wherein the storage and retrieval vehicle (3) and/or the trolley (4) is setup or calibrated by a manual storage of the position of the position data, in particular by CAD data, and a subsequent position comparison trip by the detection system (11), in particular the optical detection system.

12. A method in accordance claim 11, wherein the place position (2) and the pick position (1) is configured as a first unit (13), in particular as a high bay store (5) and the placing and picking is carried out by the storage and retrieval vehicle (3) and/or of the trolley (4).

13. A method in accordance with claim 3, wherein the place position (2) and the pick position (1) is configured as a first unit (13), in particular as a high bay store (5) and the placing and picking is carried out by the storage and retrieval vehicle (3) and/or of the trolley (4).

14. A method in accordance with claim 2, wherein the place position (2) and the pick position (1) is configured as a first unit (13), in particular as a high bay store (5) and the placing and picking is carried out by the storage and retrieval vehicle (3) and/or of the trolley (4).

15. A method in accordance with claim 14, wherein the pick position (1) and the place position (2) is configured as a second unit (9), in particular a machine (14), a cleaning station (14), a measuring station (14) and/or a setup station (14) and the picking is carried out by the storage and retrieval vehicle (3) and/or of the trolley (4).

16. A method in accordance with claim 13, wherein the pick position (1) and the place position (2) is configured as a second unit (9), in particular a machine (14), a cleaning station (14), a measuring station (14) and/or a setup station (14) and the picking is carried out by the storage and retrieval vehicle (3) and/or of the trolley (4).

17. A method in accordance with claim 12, wherein the pick position (1) and the place position (2) is configured as a second unit (9), in particular a machine (14), a cleaning station (14), a measuring station (14) and/or a setup station (14) and the picking is carried out by the storage and retrieval vehicle (3) and/or of the trolley (4).

18. A method in accordance with claim 11, wherein the pick position (1) and the place position (2) is configured as a second unit (9), in particular a machine (14), a cleaning station (14), a measuring station (14) and/or a setup station (14) and the picking is carried out by the storage and retrieval vehicle (3) and/or of the trolley (4).

19. A method in accordance with claim 4, wherein the pick position (1) and the place position (2) is configured as a second unit (9), in particular a machine (14), a cleaning station (14), a measuring station (14) and/or a setup station (14) and the picking is carried out by the storage and retrieval vehicle (3) and/or of the trolley (4).

20. A method in accordance with claim 3, wherein the pick position (1) and the place position (2) is configured as a second unit (9), in particular a machine (14), a cleaning station (14), a measuring station (14) and/or a setup station (14) and the picking is carried out by the storage and retrieval vehicle (3) and/or of the trolley (4).
